(19) United States
(12) Patent Application Publication
(10) Pub. No.: US 2014/0001217 A1
(43) Pub. Date: Jan. 2, 2014

(54) SUPPORT STRUCTURE FOR DETACHABLY MOUNTING A DISPLAY UNIT

(71) Applicants: Matthew JOLDA, Sunnyvale, CA (US); Nathaniel Coser, Palo Alto, CA (US)

(72) Inventors: Matthew JOLDA, Sunnyvale, CA (US); Nathaniel Coser, Palo Alto, CA (US)

(21) Appl. No.: 13/537,957

(22) Filed: Jun. 29, 2012

(51) Int. Cl. B60R 7/04; B60R 7/00

(52) U.S. Cl. 224/275; 224/547

(57) ABSTRACT

A support structure for detachably mounting a display unit to a vehicle structure, a headrest, and a vehicle are described.

### BACKGROUND OF THE INVENTION

1. Field of the Invention

The present invention relates to a support structure for detachably mounting a display unit to a vehicle structure, a headrest comprising a mounting element for detachably coupling a display unit to the headrest, and a vehicle comprising a headrest.

2. Description of the Background Art

The development and sales of portable computers or personal digital assistants comprising a large touch screen display, so-called tablet devices or tablet PCs, has increased. These devices are providing their users with many different types of technological interaction, for example e-mail, entertainment, web surfing, multimedia and social networking. Therefore, it becomes essential for users to take these devices with them wherever they go. Thus, it is desirable that these devices are able to be used and mounted inside of transport vehicles, for example automobiles, trains or airplanes. Mounting these devices inside the vehicle would relieve strain on the users who would normally hold the devices in their hands or lap for extended periods of time while travelling. For example, devices exist which allow the mounting of a tablet device on the backside of an automobile seat. However, several notable issues should be considered:
the mounting system should be usable with a wide variety of different tablet devices;
the mounting systems should be robust to offer a secure and stable connection between the tablet device and the vehicle;
mounting or unmounting of the tablet device should not require complex interactions but should be performed by simple tasks;
a change of orientation of the tablet device from landscape to portrait and vice versa should be possible;
it should be possible to charge the batteries of the tablet device while being mounted to the vehicle; and/or
the mounting system should be easily installable as an accessory for aftermarket purchase.

### SUMMARY OF THE INVENTION

According to an embodiment, a support structure for detachably mounting a display unit to a vehicle structure is provided. The support structure comprises a first mounting element which comprises an opening with an inner circumferential surface. The first mounting element is attachable to one of the vehicle structure and the display unit. The support structure comprises furthermore a second mounting element which is configured such that an outer circumferential surface of the second mounting element is insertable into the opening of the first mounting element. The second mounting element is attachable to the other one of the vehicle structure and the display unit. Furthermore, a circumferential groove is provided in a circumferential direction at one of the inner circumferential surface and the outer circumferential surface. At the other one of the inner circumferential surface and the outer circumferential surface at least one protrusion is provided. The first and second mounting elements are configured such that the at least one protrusion engages with the circumferential groove when the second mounting element is inserted into the opening of the first mounting element.

According to another embodiment, a headrest for a vehicle is provided. The headrest comprises a mounting element for detachably coupling to a mounting element of a display unit. The mounting element of the headrest has a circular cylindrical shape and at least one protrusion which is provided at an outer circumferential curved surface of the mounting element of the headrest.

According to a further embodiment of the present invention, a vehicle comprising a headrest is provided. The headrest comprises a mounting element for detachably coupling to a mounting element of a display unit. The mounting element of the headrest has a circular cylindrical shape and at least one protrusion is provided at an outer circumferential curved surface of the mounting element of the headrest.

Although specific features described in the above summary and the following detailed description are described in connection with specific embodiments, it is to be understood that the features of the embodiments described can be combined with each other unless specifically noted otherwise.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a headrest according to an embodiment of the present invention;

FIG. 2 shows mounting elements of a support structure according to an embodiment of the present invention;

FIG. 3 shows a display unit comprising a mounting element according to an embodiment of the present invention;

FIG. 4 shows a perspective partly sectional view of a support structure according to an embodiment of the present invention;

FIG. 5 shows a sectional view of a support structure according to an embodiment of the present invention; and

FIG. 6 shows a vehicle according to an embodiment of the present invention.

### DETAILED DESCRIPTION

In the following, exemplary embodiments of the invention will be described in detail. It is to be understood that the following description is given only for the purpose of illustrating the principles of the invention and is not to be taken in a limiting sense. Rather, the scope of the invention is defined only by the appended claims and not intended to be limited by the exemplary embodiments hereinafter.

It is to be understood that in the following detailed description of the various embodiments, any direct connection or coupling between components or other physical or functional units shown in the drawings and described herein could also be implemented in an indirect connection or coupling. Same reference signs in the various instances of the drawings refer to similar or identical components. It is furthermore to be understood that the features of the various exemplary embodiments described herein may be combined with each other unless specifically noted otherwise.

According to an embodiment of the present invention, a support structure for detachably mounting a display unit to a vehicle structure comprises a first mounting element and a second mounting element. The first mounting element comprises an opening with an inner circumferential surface. The first mounting element may be attached to one of the vehicle structure and the display unit. The second mounting element is configured such that an outer circumferential surface is insertable into the opening of the first mounting element. The second mounting element may be attached to the other one of the vehicle structure and the display unit. In the following description the first mounting element is attached to the display unit, and the second mounting element is attached to the vehicle. However, the arrangement may be vice versa such that the first mounting element is attached to the vehicle structure and the second mounting element is attached to the display unit. A circumferential groove is provided in a circumferential direction at one of the inner circumferential surface and the outer circumferential surface. Furthermore, at least one protrusion is provided at the other one of the inner circumferential surface and the outer circumferential surface. In the following description, the circumferential groove is provided in the circumferential direction at the inner circumferential surface of the first mounting element, and four protrusions are provided at the outer circumferential surface of the second mounting element. However, the arrangement of the groove and the protrusions may be just vice versa such that the circumferential groove is provided at the outer circumferential surface of the second mounting element and the protrusions are provided at the inner circumferential surface of the opening of the first mounting element. The first and the second mounting elements are configured such that the protrusions engage with the circumferential groove when the second mounting element is inserted into the opening of the first mounting element.

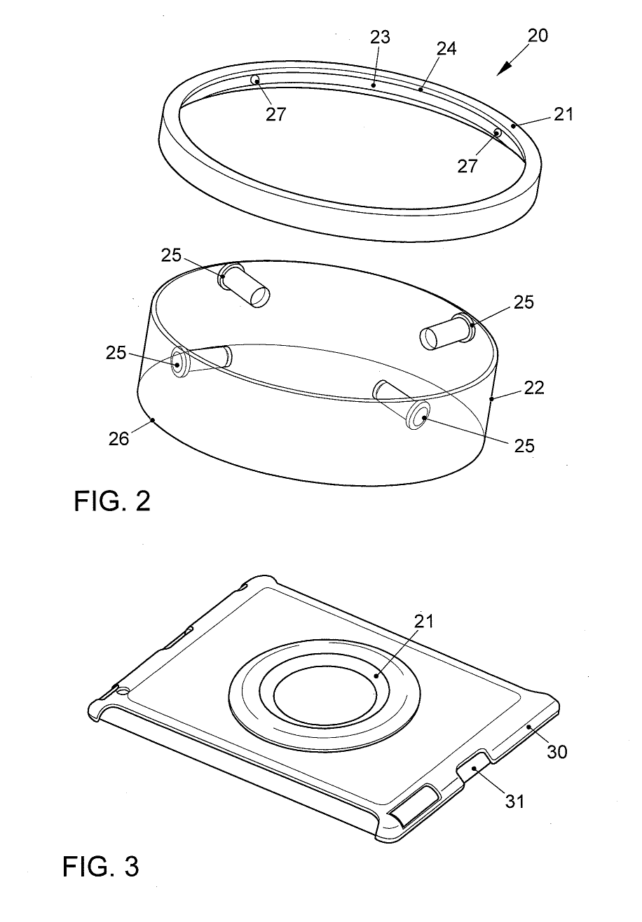

FIG. 2 shows an exemplary embodiment of a support structure 20 comprising a first mounting element 21 and a second mounting element 22. The first mounting element 21 will be called in the following also mounting adaptor ring 21. The mounting adaptor ring 21 has an annular shape and a groove 23 is provided at an inner circumferential surface 24 of the ring 21. As shown in FIG. 3, the mounting adaptor ring 21 may be coupled to a custom tablet case 30 into which a tablet PC 31 may be inserted. The second mounting element 22 will be called in the following also mount 22. The mount 22 comprises four protrusions 25 which resiliently protrude in a radial direction from the outer circumferential surface 26 of the mount 22. The outer circumferential surface 26 of the mount 22 matches in a form-fitting manner to the inner circumferential surface 24 of the adaptor ring 21. The protrusions 25 are configured such that they are resiliently urged into the direction of the center of the mount 22 when the mount 22 is inserted into the adaptor ring 21. Thus, when being urged, the protrusions 25 do not protrude from the outer circumferential surface 26, and the mount 22 can be inserted into the adaptor ring 21. During insertion the protrusions 25 are urged by a contact to the inner circumferential surface 24. When the protrusions 25 face the groove 23 they can protrude from the outer circumferential surface 26 and snap into the groove 23.

According to an embodiment, the protrusions 25 comprise spring loaded detents, for example spring loaded ball bearing detent pins. The ball bearings compress an internal spring and provide a resilient protrusion. The ball bearings are urged into the direction of the center of the mount 26 when they contact the inner circumferential surface 24 during insertion of the mount 22 into the adaptor ring 21. The ball bearings then press into the groove 23 via spring force, locking the adaptor ring 21 to the mount 22. Using spring loaded bearing balls, the tablet case 30 can be easily pressed into position as well as easily pulled off of the mount 22. No extra buttons have to be pressed or screws have to be screwed or unscrewed in order to attach or detach the table case 30 from the mount 22.

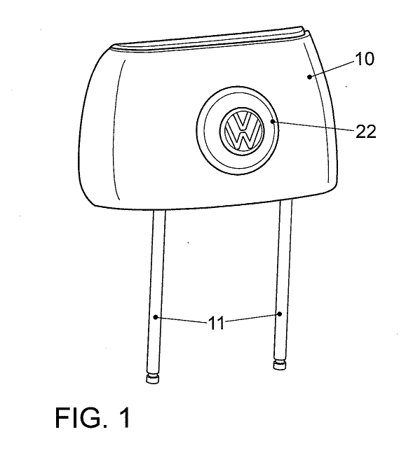

As shown in FIG. 1, the mount 22 may be coupled to a backside of a headrest 10. The mount 22 may be integrated into the headrest 10 and may have a coupling to bars 11 of the headrest 10 thus providing a reliable and robust connection to the vehicle via the vehicle seat. The headrest 10 with the integrated mount 22 may be an accessory part which can be easily installed into any vehicle. This can be done without having to perform modifications to the existing seat. Providing the headrest as an accessory part would allow for one headrest model to be used in any of a fleet of vehicles provided the headrest mounting bars 11 are the same.

As shown in FIGS. 1-3, the adaptor ring 21 and the mount 22 may have a circular shape. Therefore, a specific orientation of the tablet case 30 to be attached or detached is not required. Furthermore, the tablet case 30 may be freely rotated 360°. As shown in FIG. 2, the groove 23 is provided with for example four indents 27 (only two of the indents 27 are visible in FIG. 2). At certain rotating positions of the mount 22 relative to the adaptor ring 21 the protrusions 25 may snap additionally into the indents 27. This allows the free rotating tablet case 30 to easily “lock” into for example a portrait or landscape orientation. When the tablet case 30 is arranged in a portrait or landscape orientation with respect to ground, the protrusions 25 and indents 27 may be oriented in an “X” relative to ground such that their forces are more equally distributed when the tablet case 30 is mounted or unmounted.

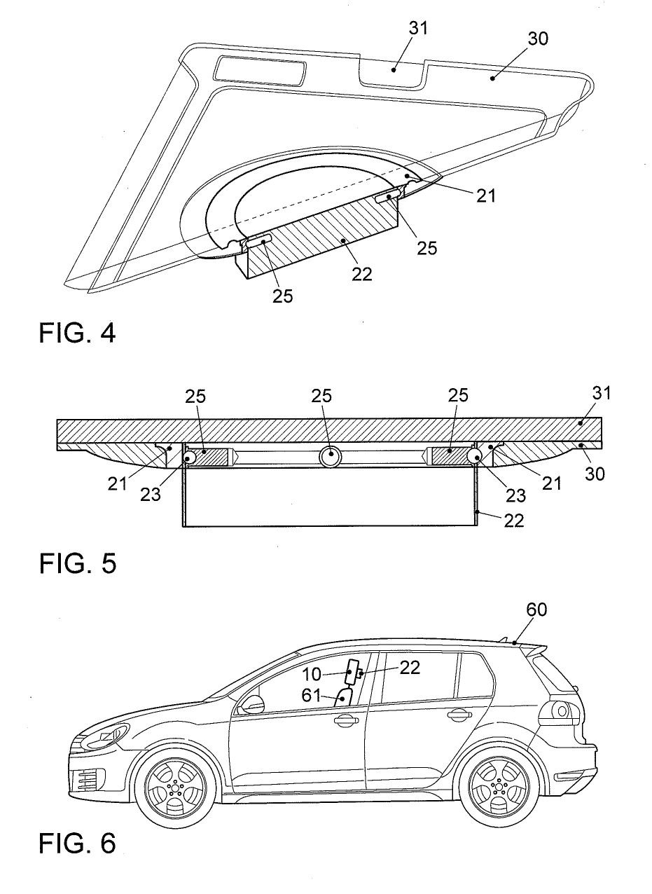

FIG. 4 illustrates the connection of a tablet device 31 cased in a tablet casing 30 to the mount 22, via the adaptor ring 21.

FIG. 5 shows a cutaway of interaction between the adaptor ring 21 and the protrusions 25 of the mount 22 when the adaptor ring 21 is attached to the mount 22. The interaction between the bearing balls of the protrusions 25 and the groove 23 is shown. The protrusions 25 press into the groove 23 of the adaptor ring 21. The locking between the protrusions 25 and the groove 23 is not permanent, but each protrusion may have a holding force of 45 N (10 lbs).

FIG. 6 shows a vehicle 60 comprising a seat 61 with a headrest 10. The headrest 10 comprises at the backside of the headrest 10 a mounting element 22, for example the mounting element 22 which has been described above in connection with FIGS. 1-5.

While exemplary embodiments have been described above, various modifications may be implemented in other embodiments. For example, the mount 22 may comprise additionally electrical contact for providing electrical energy via corresponding electrical contacts of the adaptor ring 21 to the tablet device 31 for charging or operating the tablet device 31 when being coupled to the vehicle 60.

Finally, it is to be understood that all the embodiments described above are considered to be comprised by the present invention as it is defined by the appended claims.

What is claimed is:

1. A support structure for detachably mounting a display unit to a vehicle structure, the support structure comprising:
a first mounting element comprising an opening with an inner circumferential surface, the first mounting element being attachable to one of the vehicle structure and the display unit; and
a second mounting element, the second mounting element being configured such that an outer circumferential surface of the second mounting element is insertable into the opening of the first mounting element,
wherein the second mounting element is attachable to the other one of the vehicle structure and the display unit,
wherein a circumferential groove is provided in a circumferential direction at one of the inner circumferential surface and the outer circumferential surface, and at least one protrusion is provided at the other one of the inner circumferential surface and the outer circumferential surface, and
wherein the first and second mounting elements are configured such that the at least one protrusion engages with the circumferential groove when the second mounting element is inserted into the opening of the first mounting element.

2. The support structure according to claim 1, wherein the at least one protrusion comprises a resilient protrusion resiliently protruding from the other one of the inner circumferential surface and the outer circumferential surface.

3. The support structure according to claim 2, wherein the resilient protrusion comprises a spring loaded detent.

4. The support structure according to claim 3, wherein the spring loaded detent has a holding force of about 45 N when the spring loaded detent is engaged with the groove.

5. The support structure according to claim 1, wherein the first and second mounting elements are configured such that the inner circumferential surface and the outer circumferential surface match in a form fitting manner.

6. The support structure according to claim 1, wherein the opening has a circular shape.

7. The support structure according to claim 1, wherein the second mounting element has a circular cylindrical shape.

8. The support structure according to claim 1, wherein the vehicle structure comprises a headrest coupled via a headrest support structure to a seat of the vehicle, and wherein the second mounting element comprises a support structure for coupling the second mounting element to the headrest support structure.

9. The support structure according to claim 1, wherein the groove is provided with at least one indent.

10. The support structure according to claim 9, wherein the at least one protrusion comprises four protrusions and the at least one indent comprises four indents, and wherein each of the four protrusions extends into a corresponding one of the four indents when the second mounting element is inserted into the opening of the first mounting element.

11. The support structure according to claim 10, wherein the four protrusions are arranged in an X-arrangement, wherein each of the four protrusions extends towards a corresponding direction of one of the legs of an X.

12. The support structure according to claim 1, wherein the first mounting element comprises a first electrically conducting contact point and the second mounting element comprises a second electrically conducting contact point, and wherein the first electrically conducting contact point contacts the second electrically conducting contact point when the second mounting element is inserted into the opening of the first mounting element.

13. The support structure according to claim 1, wherein the display unit comprises a case into which a display is insertable, the display comprising a computer display, a gaming display or a tablet computer.

14. The support structure according to claim 1, wherein the first mounting element is attachable to the display unit, and the second mounting element is attachable to the vehicle structure.

15. A headrest comprising a mounting element for detachably coupling to a mounting element of a display unit, wherein the mounting element of the headrest has a circular cylindrical shape and wherein at least one protrusion is provided at an outer circumferential curved surface of the mounting element of the headrest.

16. A vehicle comprising a headrest, the headrest comprising a mounting element for detachably coupling to a mounting element of a display unit, wherein the mounting element of the headrest has a circular cylindrical shape and wherein at least one protrusion is provided at an outer circumferential curved surface of the mounting element of the headrest.
